(19) United States
(12) Patent Application Publication
(10) Pub. No.: US 2026/0136157 A1
(43) Pub. Date: May 14, 2026

(54) INTEGRATING MULTIMODAL TRACKING DATA FOR ASSETS WITH DISCONTIGUOUS FEATURES

(71) Applicant: T-Mobile USA, Inc., Bellevue, WA (US)

(72) Inventors: Sudhanshu Pandey, Sammamish, WA (US); Raghavendra Kulkarni, Redmond, WA (US)

(21) Appl. No.: 18/945,397

(22) Filed: Nov. 12, 2024

(51) Int. Cl. H04W 4/029; H04W 24/02

(52) U.S. Cl. CPC H04W 4/029; H04W 24/02

(57) ABSTRACT

A method is disclosed for assessing and reporting threats to assets, which possess both physical and digital features. The method involves gathering resources related to the asset, despite the resources being structured in different formats. Relevancy models, trained to handle these diverse formats, assign relevancy scores to the resources, which are used to identify pertinent resources. The identified resources are scraped for logs associated with the asset's physical or digital features. These logs are integrated into a tracking history of the asset, based on a correspondence found within the logs. The method includes estimating a threat level for the asset based on its tracking history.

### BACKGROUND

Asset tracking is the process of monitoring and managing an organization's physical and digital assets using technologies like GPS and RFID, as well as software systems, to maintain real-time records of location, condition, and usage. Managing and monitoring assets includes scanning labels attached to the assets or by using tags which broadcast location, and by keeping track of the creation, usage, storage, and distribution of files, documents, multimedia content, and other digital data. These technologies can be used for tracking usage and performance of assets physically and digitally, as well as for detecting threats to such assets.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an asset-tracking system 300.

FIG. 4 is a flowchart diagram that illustrates operations of a method for reconciling multimodal tracking data for improved threat detection to assets with discontiguous features in accordance with one or more embodiments of the present technology.

FIG. 5 is a block diagram that illustrates an example of an artificial intelligence system in which at least some operations described herein can be implemented.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many organizations maintain digital and physical assets that require various procedures or actions to ensure compliance with a policy. These assets can include, for example, servers that store the organization’s data, personal computing devices used by employees of the organization, or special-purpose computing devices (such as medical equipment or points-of-sale), as well as any data stored on these devices and software executed by the devices. Each of these assets can be subject to a cybersecurity policy, a regulatory compliance policy, a quality assurance policy, a data retention or classification policy, or any of various other types of policies. For example, an organization may implement a cybersecurity policy that requires each physical asset to receive regular updates to its malware detection software and to perform regular vulnerabilities scans. In these types of organizations, asset tracking is crucial for determining whether the assets are in compliance with any applicable policies and to detect threats to a system because it provides real-time visibility, allowing organizations to quickly identify unauthorized movements or anomalies.

One example type of organization that can benefit from asset tracking is a telecommunications system operator. Telecommunications systems are critical infrastructure, and their vulnerability to foreign attacks has significant national security, economic, and social implications. However, the complexity of a telecommunications network makes asset tracking difficult due to the vast number of interconnected devices and components spread across wide geographic areas, which can be challenging to monitor and manage in real-time. For example, it can be difficult to quickly determine which devices have received a critical security update, or to immediately identify an exact physical location of a personal computing device that has been compromised. Additionally, the dynamic nature of telecom networks—with frequent upgrades, maintenance, and reconfigurations—complicates the accurate tracking and updating of asset information. However, asset tracking implementations described herein can be used in any environment where assets are required to comply with a policy.

One solution to such complexity is to link all of an organization’s critical asset data to a common point of reference. This common point of reference includes a single, authoritative source of truth for asset data, which includes physical location, IP address, current state of vulnerabilities, if the IP was repurposed, and scanning percentage, among other features. This common reference can be maintained through data integration, data quality management, and data governance practices, enabling organizations to make informed decisions, improve operational efficiency, and enhance data-driven initiatives.

However, there are obstacles to implementing such an approach. Different departments or systems within an organization may maintain separate data repositories, leading to fragmented and inconsistent data that is difficult to integrate and manage centrally. Furthermore, integrating data can be technically complex and time-consuming as each source and system can have its own data format and API (Application Programming Interface).

The disclosed technology solves these problems and others by reconciling multimodal tracking data for improved threat detection in assets with discontiguous features. An example of such a process includes receiving a natural language prompt concerning cybersecurity threats to a telecommunications network service, which includes both physical and digital features. Such a system can then crawl a set of data silos for cybersecurity resources related to the service.

These data silos can include various APIs, and the cybersecurity resources can be structured in multiple formats. Relevant resources are then identified based on relevancy scores determined by relevancy models, which are trained to accept the different and provide scores on a common scale. The identified resources are scraped for security logs associated with either the physical or digital features of the service. These logs can include security logs, maintenance logs, or operational logs. The logs are integrated into a complete tracking history of the service, with the best fit determined by a combination of the service's digital and physical features. A cybersecurity threat level for the service is then estimated based on this complete tracking history. Finally, the estimated cybersecurity threat level is generated for display on a user interface as a conversational response to the natural language prompt, including the complete tracking history of the service as a reference.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

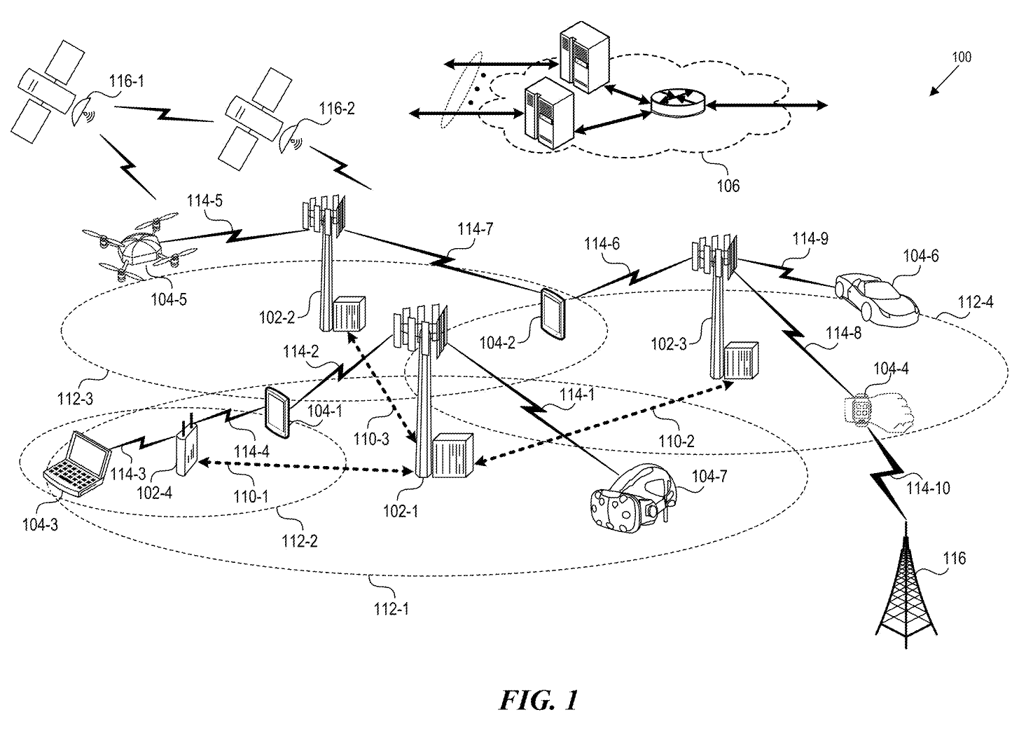

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

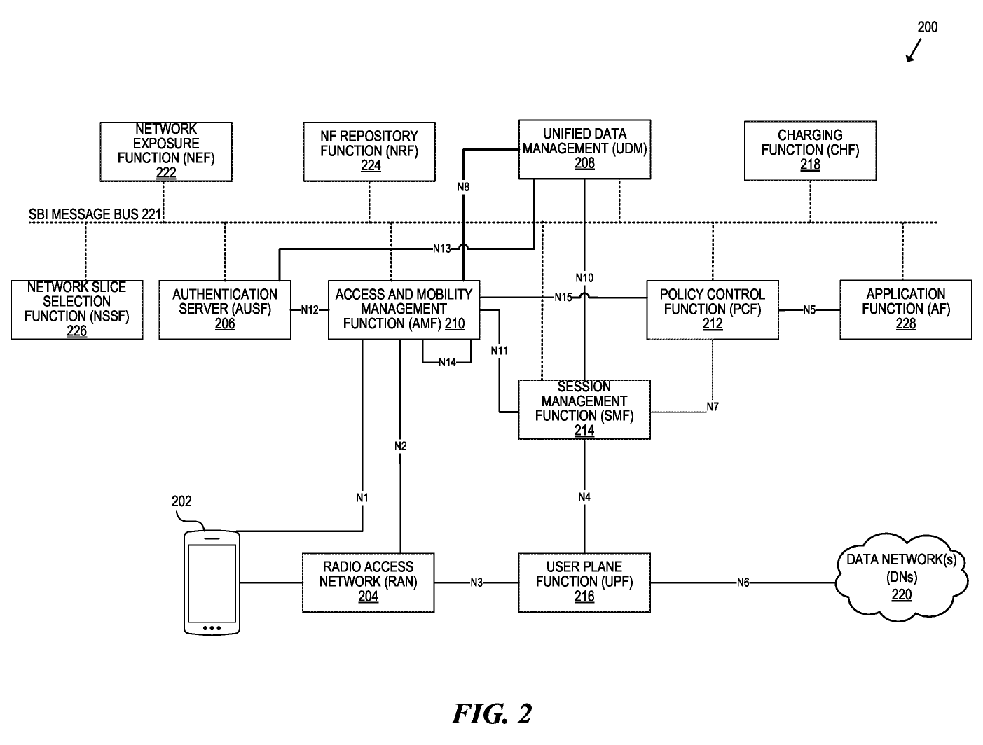

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Integrating Multimodal Tracking Data for Assets with Discontiguous Features

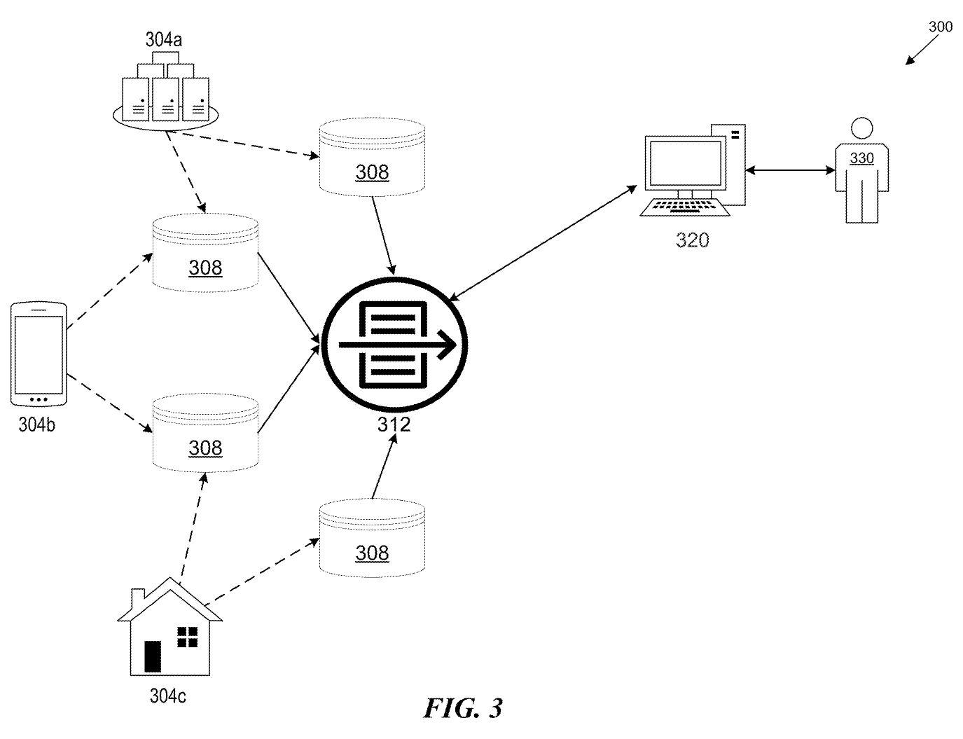

FIG. 3 is a block diagram that illustrates an asset-tracking system 300. The asset-tracking system 300 includes assets 304a, 304b, and 304c, as well as data silos 308, and an integrated tracking history 312. The system 300 can also include a terminal 320, which can be accessed by a user 330 of the asset-tracking system 300.

The assets 304a, 304b, and 304c can include resources belonging to an organization (e.g., equipment, devices, real property, chattel, or intellectual property). The assets 304a, 304b, and 304c can include physical features and/or digital features. For example, in the case of an asset that includes a patent, physical features of the patent-asset can include the name and organization of the inventor, or the room where the server is located where the files regarding ownership of the patent-asset are saved. Digital features of the patent-asset can include a file system address, an encryption key or passcode, or metadata tags to assist with high-level strategy and future forecast modeling. In another example, in the case of an asset that includes a computing device (such as a server system), the asset can include physical features such as processors, memory devices, and an outer casing that holds the processors and memory devices. Digital features of the server system include any software or instruction sets running on the server system, as well as any data stored in the memory devices.

The data silos 308 are where the features of the assets 304a, 304b, and 304c are stored and updated. Some assets can have different features saved to different data silos 308. Problems can arise in situations where a single asset is owned or used by multiple groups within an organization. For example, each group that uses the asset can save features of the asset to its data silo, and these features can be redundant, overlapping, or interdependent. To illustrate, one group can manage the digital storage of the patent-asset, while another group can include the inventor of the patent-asset. If the inventor is reassigned, however, and the group that manages the digital storage of the patent-asset does update the features associated with the patent-asset on its data silo, it can delay the tracking processes (e.g., seeking the inventor signature) for the patent-asset. In another example, one group may be responsible for maintaining the physical assets of a server system, while another group is responsible for maintaining antivirus software on the server system and yet another group stores their data on the server system.

The asset-tracking system 300 can solve this problem and others by providing a connection between the data silos 308. As illustrated in FIG. 3, the connection can include the integrated tracking history 312. The integrated tracking history 312 can include resources related to the assets 304a, 304b, and 304c, which it identifies according to a relevancy score, output by a relevancy model trained on asset features incorporated by the integrated tracking history 312 from crawling the data silos 308. The system 300 can also crawl the data silos 308 by referring to an index comprising shared identifying information (e.g., an asset index comprising shared asset identifiers, or unique identifying information specific to each asset, and recorded to the resources in the data silos). The shared identifying information can include tags, labels, or codes (e.g., RFIDs, QR Codes, Barcodes, or metadata tags).

The integrated tracking history can include a model (e.g., a large language model (LLM)), or a collection of models (e.g., a set of relevancy models). The set of relevancy models can assess relevancy scores for the related resources, where each model of the set of relevancy models has been trained on resources of a specific format. For example, a first relevancy model can be trained to detect similarities between resources stored in a first format (e.g., text), while a second relevancy model can be trained to detect similarities between resources stored in a second format (e.g., relational database tables). The system 300 can combine a first output of the first relevancy model with a second output of the second relevancy model by normalizing the relevancy scores and aggregating the normalized scores. In such implementations, the normalized scores can then be comparable according to a common scale.

In those implementations in which the model includes an LLM, the LLM can generate a threat level for the asset as a conversational response. The conversational response can be transmitted to an endpoint, e.g., the terminal 320, where it can be generated for display to the user 330. In some implementations, the integrated tracking history 312 updates according to a schedule, or it can update in response to natural language prompts, e.g., from the user 330. The conversational response can be transmitted to the terminal in response to the natural language prompt, and can include an annotated, readable version of the integrated tracking history 312, which has been sliced to include only relevant features of the asset, and which data silos served as the origins for the features.

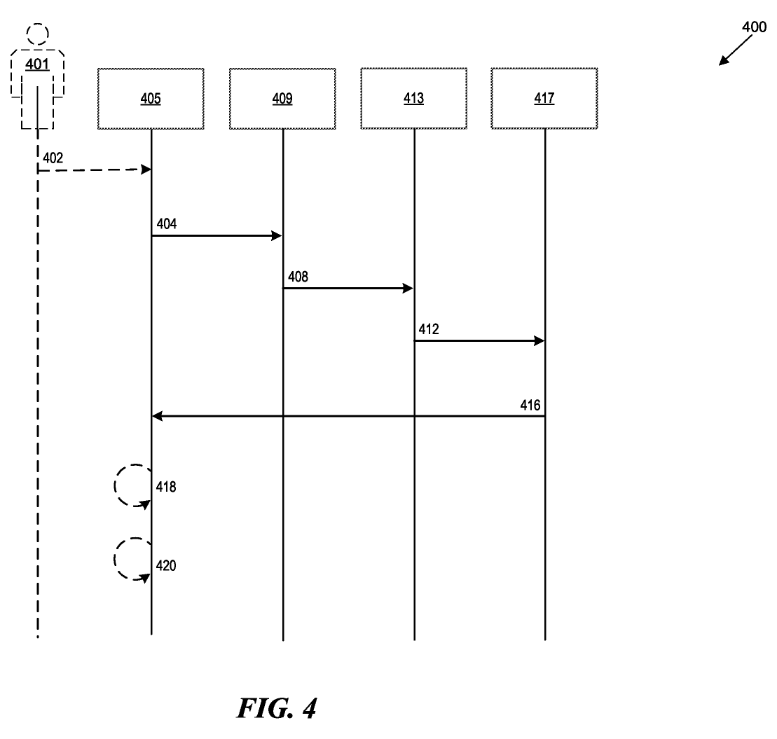

FIG. 4 is a flowchart diagram that illustrates operations of a method 400 for reconciling multimodal tracking data for improved threat detection to assets with discontiguous features, in accordance with one or more embodiments of the present technology. The method 400 can be recorded as instructions on a non-transitory, computer-readable storage medium and executed by one or more processors of a system, such as the asset-tracking system 300. The method 400 can be performed by at least one data processor of a system when the system executes the recorded instructions. The method 400 can be performed by at least one hardware processor of a system by executing instructions stored by at least one non-transitory memory also included in the system.

In some implementations, the method 400 includes an operation 402 that involves receiving a natural language prompt concerning a policy associated with an asset of a telecommunications network. The asset can be a service (e.g., software designed to perform specific tasks which can be used by other software applications or services). The service can be a self-contained, modular, and re-usable piece of software, which can be scaled independently to handle varying loads and performance requirements, and loosely coupled to other services. The natural language prompt can be received at an asset tracking interface generated by the asset-tracking system 300, and sent from a client 401. The asset can include discontiguous features (e.g., physical features and digital features). In some implementations, the physical features include components of the wireless telecommunication network 100 (e.g., hardware, a server, computer host, or a device), or features related to such components (e.g., a location of a server). In some implementations, the digital features include functions of the 5G Core Network architecture 200 (e.g., software, an API, or data), or features related to such functions. The natural language query can specify one or more of the features of an asset (e.g., “has server A received its updated security patch?”), or can inferentially refer to an asset’s features without specifying them (e.g. “are there any servers that have not received the new security patch?”).

The method 400 includes an operation 404 that involves crawling a data collection 409 for resources that are related to the asset. The data collection can include a set of data silos that are disconnected, with each data silo in the set protected by its own authorization and authentication protocols, and/or having a unique API, query language, or query syntax. Each data silo in the set can correspond to a separate organization within the same business. The separate organizations can have overlapping oversight or ownership of the asset. The separate organizations can have unique or distinct jargon from each other for referring to the same asset, or the same features of the same asset, or they can have particular ways of measuring the values of the same features.

The resources from the data collection 409 can be multimodal (e.g., recorded in multiple formats). The resources can include cybersecurity resources related to the service. Each resource of the cybersecurity resources can have a structure that is different from the other cybersecurity resources. These structures can correspond to a variety of formats. Resources can be stored as relational database tables, xml files, json files, text files, image files, video files, and/or audio files.

The method 400 includes an operation 408 that involves identifying related resources based on relevancy scores. The related resources can be identified by relevancy models 413. In some implementations, the relevancy models 413 are trained to accept the multimodal resources as input and output relevancy scores. The relevancy models 413 can be trained to accept a variety of formats. For example, a first relevancy model can be trained to detect similarities between resources stored as images, and a second relevancy model can be trained to detect similarities between resources stored as text, and the natural language prompt received from the client 401. The relevancy scores of all of the relevancy models 413 can be comparable according to a common scale (e.g., probabilities between 0 and 1). In some implementations, the relevancy models 413 are saved locally to the data collection 409, or accessed remotely (e.g., via a remote procedure call to a separate node on a shared network, or as a query to a cloud service, either third-party or private).

In some implementations, the digital features and the physical features of the asset include text. The text can include signature tokens (e.g., a token that occurs more frequently in a relevant resource than in an irrelevant resource, where a relevant resource pertains to the asset). An individual relevancy model, from the relevancy models, can determine a relevancy score by calculating frequencies of the signature tokens among the resources from the set of data silos, and ranking the resources according to these frequencies. For example, a resource with a greater frequency would have a higher rank, and identifying related resources would include selecting those resources with ranks that satisfy a threshold. In some implementations, the ranks will score at, above, or below a cut-off. In some implementations, this would include calculating the term frequency-inverse document frequency (tf-idf) for terms related to the asset among the resources from the set of data silos.

In some implementations, the cut-off for related resources is determined by setting a test cut-off at a highest rank. A test group of related resources can be selected above the test cut-off and plotted as points on a graph (e.g., using word2vec, doc2vec, GloVe, or another model for embedding the resources) such that the points form a cluster. The method can include determining a center of the cluster, and distances between the points and the center of the cluster. The method can include calculating a first measure of error based on the distances. From here, the method can include setting iteratively lower test cut-offs, and selecting the increasingly larger test groups of related resources that are associated with the lower test cut-offs. Additional measures of error can be calculated from the increasingly larger test groups, based on the distances calculated between the resources (e.g., when embedded as points on graphs) to the centers of clusters that are formed by the resources. These additional measures of error can be compared with each other, along with the first measure of error, and the largest difference in error can be used to determine the ideal cut-off from the test cut-offs. For example, when plotted on a graph with the test cut-off ranking along the x-axis and the resulting error along the y-axis, the ideal cut-off for the method would be apparent as the cut-off occurring just before the largest jump in error. In some implementations, the elbow method can be used to determine the cut-off, or other such methods employing trial and error.

The method 400 includes an operation 412 that involves scraping the related resources for logs 417. The logs can include records of events, transactions, or activities related to the asset. In some implementations, the logs 417 are security logs, and the resources are associated with a physical feature or a digital feature of a service. For example, the logs can be entries in a relational database table, or segments of an audio, video, or text file, related to a feature of the asset. In some implementations, the scraping includes determining logs 417 that are associated with the discontiguous features of the asset.

The method 400 includes an operation 416 that involves integrating the logs 417 into a tracking history of the asset. In some implementations, the operation 416 occurs by retrieving the logs 417 from the related resources (as determined by the relevancy models 413) and forming the tracking history at the asset tracking interface 405, as illustrated. The logs can be integrated into a tracking history of the service based on a correspondence of the logs. In some implementations, the correspondence is determined by combining the digital features and the physical features of the asset and/or service. For example, the correspondence can be determined by aligning the logs using a common key value that is shared by the physical and digital features. The common value can be shared between the logs, and associated with the asset. Integrating the logs into a tracking history can include joining the logs on the common value, and combining or eliminating information that is redundant (e.g., repeated across the logs) from the tracking history.

In some implementations, the logs are integrated into the tracking history using a correspondence model. The correspondence model can determine the correspondence of the logs by outputting a similarity, given the logs as input. In some implementations, the correspondence model has been trained to output similarities from logs with known similarities provided as input.

In some implementations, the method 400 includes an operation 418 that involves estimating a threat level for the asset based on the complete tracking history. The threat level can be a cybersecurity threat level. the threat level is estimated using a threat detection model, and wherein the threat detection model has been trained to output threat level estimates given tracking histories with known threat levels provided as inputs.

In some implementations, the method 400 includes an operation in which the estimated threat level is translated into a conversational response. For example, a predefined template can be used to generate natural language summary, where the predefined template is one of a selection of predefined templates, and a predefined template is selected based on a severity of the estimated threat level. The natural language summary can include the threat level and key factors from the tracking history that influenced the severity.

In some implementations, the method 400 includes an operation 420 that involves generating for display, on a user interface, the cybersecurity threat level as a conversational response to the natural language prompt. The operation 420 can include generating for display the complete tracking history of the service as a reference for the cybersecurity threat level. The threat level can be generated as a conversational response using a Large Language Model (LLM) which has been trained on the resources. The LLM can be fine-tuned using threat levels that are provided as answers to questions regarding particular assets and/or particular digital and physical features. The reference provided with the threat level can include excerpts from the tracking history, or citations to specific logs or key factors, that influenced the conversational response of the LLM.

### Artificial Intelligence System

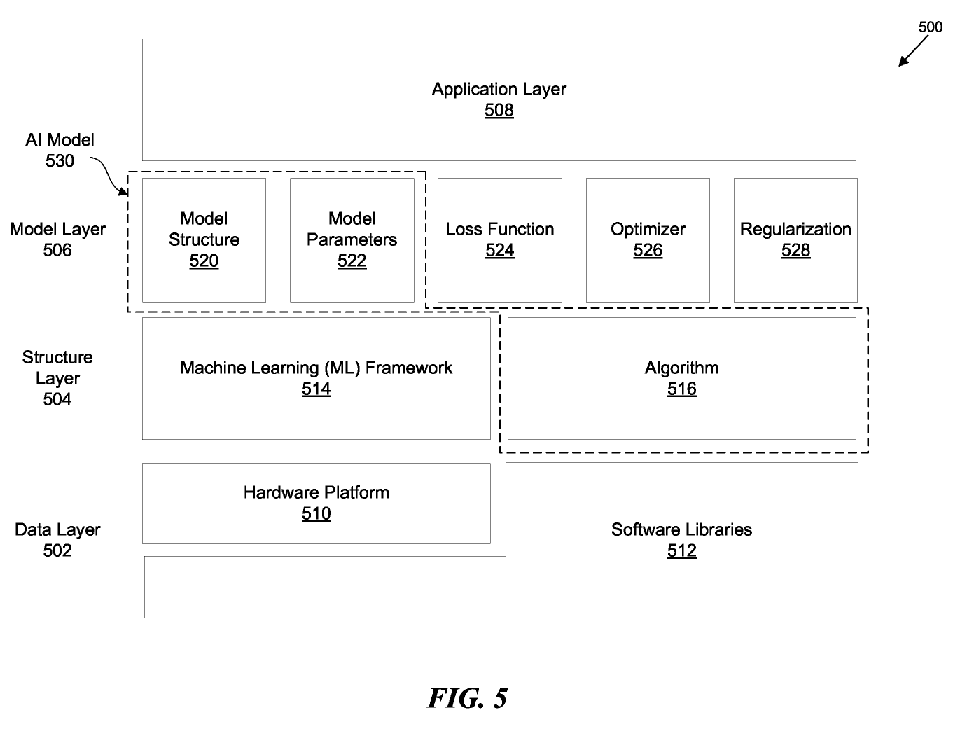

As shown in FIG. 5, the AI system 500 can include a set of layers, which conceptually organize elements within an example network topology for the AI system’s architecture to implement a particular AI model 530. Generally, an AI model 530 is a computer-executable program implemented by the AI system 500 that analyses data to make predictions. Information can pass through each layer of the AI system 500 to generate outputs for the AI model 530. The layers can include a data layer 502, a structure layer 504, a model layer 506, and an application layer 508. The algorithm 516 of the structure layer 504 and the model structure 520 and model parameters 522 of the model layer 506 together form the example AI model 530. The optimizer 526, loss function engine 524, and regularization engine 528 work to refine and optimize the AI model 530, and the data layer 502 provides resources and support for application of the AI model 530 by the application layer 508.

The data layer 502 acts as the foundation of the AI system 500 by preparing data for the AI model 530. As shown, the data layer 502 can include two sub-layers: a hardware platform 510 and one or more software libraries 512. The hardware platform 510 can be designed to perform operations for the AI model 530 and include computing resources for storage, memory, logic and networking, such as the resources described in relation to FIGS. 3 and 4. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include Infrastructure as a Service (IaaS) resources, which are computing resources, (e.g., servers, memory, etc.) offered by a cloud services provider. The hardware platform 510 can also include computer memory for storing data about the AI model 530, application of the AI model 530, and training data for the AI model 530. The computer memory can be a form of random-access memory (RAM), such as dynamic RAM, static RAM, and non-volatile RAM.

The software libraries 512 can be thought of as suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource’s instruction set architecture, allowing them to run quickly with a small memory footprint. Examples of software libraries 512 that can be included in the AI system 500 include Intel Math Kernel Library, Nvidia cuDNN, Eigen, and Open BLAS.

The structure layer 504 can include an ML framework 514 and an algorithm 516. The ML framework 514 can be thought of as an interface, library, or tool that allows users to build and deploy the AI model 530. The ML framework 514 can include an open-source library, an application programming interface (API), a gradient-boosting library, an ensemble method, and/or a deep learning toolkit that work with the layers of the AI system facilitate development of the AI model 530. For example, the ML framework 514 can distribute processes for application or training of the AI model 530 across multiple resources in the hardware platform 510. The ML framework 514 can also include a set of pre-built components that have the functionality to implement and train the AI model 530 and allow users to use pre-built functions and classes to construct and train the AI model 530. Thus, the ML framework 514 can be used to facilitate data engineering, development, hyperparameter tuning, testing, and training for the AI model 530. Examples of ML frameworks 514 that can be used in the AI system 500 include TensorFlow, PyTorch, Scikit-Learn, Keras, Cafffe, LightGBM, Random Forest, and Amazon Web Services.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model 530 through being trained while running computing resources of the hardware platform 510. This training allows the algorithm 516 to make predictions or decisions without being explicitly programmed to do so. Once trained, the algorithm 516 can run at the computing resources as part of the AI model 530 to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include asset tracking histories with known threat levels, resources with known relevancy scores measuring their relevance to known assets, and logs of physical and digital features with known correspondences and similarities. The user may label the training data based on one or more classes and trains the AI model 530 by inputting the training data to the algorithm 516. The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., service name, asset room location, asset IP address) relate to the categories (e.g., high risk, or low risk of cybersecurity attack). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The relevancy models, correspondence model, threat detection model, and the LLM fine-tuned on threat detection from tracking histories, can use unsupervised learning to identify patterns in tracking histories, security logs, and multimodal resources (e.g., to identify particular patterns in cybersecurity attacks) and so forth. In some implementations, performance of the relevancy model engine that can use unsupervised learning is improved because it can learn how to fine-tune the model by setting an ideal cut-off score for relevancy rank, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model 530 using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model 530 of the AI system 500. The model structure 520 defines the complexity of the pattern/relationship that the AI model 530 expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node’s activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model’s 530 performance during training. For instance, the loss function engine 524 can measure the difference between a predicted output of the AI model 530 and the actual output of the AI model 530 and is used to guide optimization of the AI model 530 during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model 530. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over- and under-fitting of the AI model 530. Overfitting occurs when the algorithm 516 is overly complex and too adapted to the training data, which can result in poor performance of the AI model 530. Underfitting occurs when the algorithm 516 is unable to recognize even basic patterns from the training data such that it cannot perform well on training data or on validation data. The regularization engine 528 can apply one or more regularization techniques to fit the algorithm 516 to the training data properly, which helps constraint the resulting AI model 530 and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the LLM, and/or the models for estimating threat detection, relevancy, and correspondence used by the method 400, illustrated in FIG. 4, or the system 300, illustrated by FIG. 3.

### Computer System

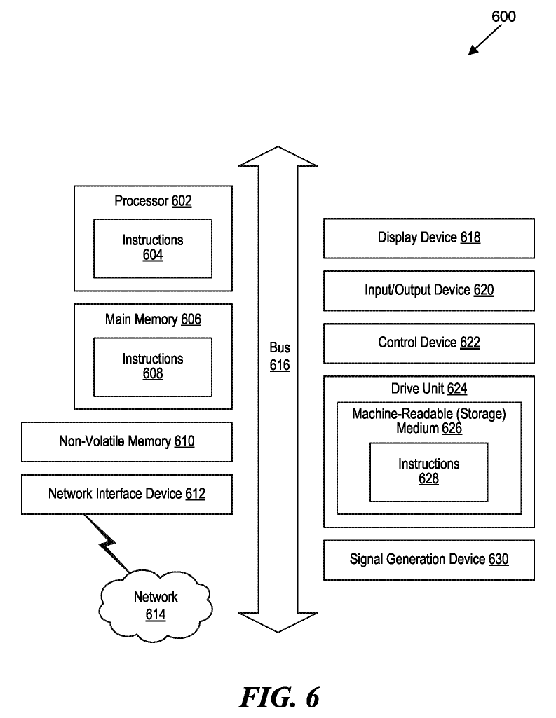

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
receiving a natural language prompt concerning threats to an asset of a telecommunications network, wherein the asset has physical features and digital features;
crawling a set of data silos using an asset index to retrieve related resources based on a shared asset identifier, wherein the shared asset identifier includes at least one of: a tag, label, or code, and wherein the related resources are structured according to a variety of formats;
assessing relevancy scores for the related resources using a set of relevancy models, wherein a first relevancy model in the set of relevancy models is trained to detect similarities between a first set of resources stored in a first format, and wherein a second relevancy model in the set of relevancy models is trained to detect similarities between a second set of resources stored in a second format different from the first format;
combining a first output of the first relevancy model with a second output of the second relevancy model by normalizing the relevancy scores and aggregating the normalized scores, wherein the normalized scores are comparable according to a common scale;
scraping the related resources for logs associated with a physical feature or a digital feature of the asset;
integrating the logs into a tracking history of the asset based on a correspondence of the logs, wherein the logs comprise records of events, transactions, or activities related to the asset, and wherein the correspondence is determined by a combination of the digital features and the physical features of the asset;
estimating a threat level for the asset based on the tracking history;
translating the estimated threat level into a conversational response using a predefined template to generate a natural language summary based on a severity of the estimated threat level, wherein the natural language summary includes the threat level and key factors from the tracking history that influenced the severity; and
generating for display, on a user interface, the conversational response to the natural language prompt, including citations to the key factors from the tracking history of the asset.

2. The method of claim 1, wherein the digital features and physical features of the asset comprise text that includes signature tokens, and wherein an individual relevancy model of the relevancy models determines a relevancy score for identifying related resources by:
calculating frequencies of the signature tokens among the resources from the set of data silos;
ranking the resources according to the frequencies of the signature tokens, such that a resource with a greater frequency has a higher rank; and
identifying related resources as the resources with ranks that satisfy a threshold.

3. The method of claim 2, wherein the threshold is determined by:
setting a test threshold at a highest rank;
selecting a test group of related resources above the test threshold and plotting them as points on a graph, such that the points form a cluster;
determining a center of the cluster;
determining distances between the points and the center of the cluster;
calculating a first measure of error based on the distances;
setting iteratively lower thresholds, selecting increasingly larger test groups of related resources, and calculating additional measures of error from the increasingly larger test groups based on measures of distance to centers of clusters;
comparing the additional measures of error with each other and with the first measure of error to determine a largest difference in error between test cut-offs; and
setting the threshold at the test threshold just before the largest difference in error.

4. The method of claim 1, wherein the correspondence of the logs comprises a common value that is shared between the logs, wherein the common value is associated with the asset, and wherein integrating the logs into a tracking history comprises:
joining the logs on the common value; and
combining redundant information from the logs.

5. The method of claim 1, wherein the logs are integrated into the tracking history using a correspondence model to determine the correspondence of the logs, wherein the correspondence includes a similarity, and wherein the correspondence model has been trained to output the similarity from logs provided as input.

6. The method of claim 1, wherein the threat level is estimated using a threat detection model, and wherein the threat detection model has been trained to output threat level estimates given tracking histories with known threat levels provided as inputs.

7. The method of claim 1, wherein the threat level is generated as the conversational response using a Large Language Model (LLM) which has been trained on the resources, wherein the LLM has been fine-tuned using threat levels that have been provided as answers given particular assets and particular digital and physical features, and wherein the citations for the threat level includes excerpts from the tracking history that influenced the conversational response of the LLM.

8. A system comprising:
at least one hardware processor; and
at least one non-transitory memory storing instructions, which, when executed by the at least one hardware processor, cause the system to:
crawl a data collection for resources related to an asset of a service,
wherein the resources include multiple formats, and
wherein the asset has physical features and digital features;
identify related resources based on relevancy scores determined by relevancy models trained to accept input that is structured according to the multiple formats,
wherein the relevancy scores are comparable;
scrape the related resources for logs associated with a physical feature or a digital feature of the asset;
integrate the logs into a tracking history of the asset based on a correspondence of the logs,
wherein the correspondence is determined by a combination of the digital features and the physical features of the asset; and
estimate a threat level for the asset based on the tracking history.

9. The system of claim 8, wherein the digital features and physical features of the asset comprise text that includes signature tokens, and wherein an individual relevancy model of the relevancy models determines a relevancy score for identifying related resources by:
calculating frequencies of the signature tokens among the resources;
ranking the resources according to the frequencies, such that resources with greater frequencies have higher ranks; and
identifying related resources as the resources with ranks above a cut-off.

10. The system of claim 9, wherein the cut-off is determined by:
setting a test cut-off at a highest rank;
selecting a test group of related resources above the test cut-off and plotting them as points on a graph, such that the points form a cluster;
determining a center of the cluster;
determining distances between the points and the center of the cluster;
calculating a first measure of error based on the distances;
setting iteratively lower test cut-offs, selecting increasingly larger test groups of related resources, and calculating additional measures of error from the increasingly larger test groups based on measures of distance to centers of clusters;
comparing the additional measures of error with each other and with the first measure of error to determine a largest difference in error between test cut-offs; and
setting the cut-off at the test cut-off just before the largest difference in error.

11. The system of claim 8, wherein the correspondence of the logs comprises a common value that is shared between the logs, wherein the common value is associated with the asset, and wherein integrating the logs into a tracking history comprises:
joining the logs on the common value; and
combining redundant information from the logs.

12. The system of claim 8, wherein the logs are integrated into the tracking history using a correspondence model to determine the correspondence of the logs, wherein the correspondence includes a similarity, and wherein the correspondence model has been trained to output the similarity from logs provided as input.

13. The system of claim 8, wherein the threat level is estimated using a threat detection model, and wherein the threat detection model has been trained to output threat level estimates given tracking histories with known threat levels provided as inputs.

14. The system of claim 8, wherein the threat level is generated as a conversational response using a Large Language Model (LLM) which has been trained on the resources, wherein the LLM has been fine-tuned using threat levels that have been provided as answers given particular assets and particular digital and physical features, and wherein the threat level includes references to logs that influenced the conversational response of the LLM.

15. A non-transitory, computer-readable storage medium comprising instructions recorded thereon, wherein the instructions when executed by at least one data processor of a system, cause the system to:
crawl a data collection for multimodal resources related to an asset that comprises discontiguous features;
identify related resources based on relevancy scores determined by relevancy models trained to accept the multimodal resources as input;
scrape the related resources for logs associated with the discontiguous features; and
integrate the logs into a tracking history of the asset.

16. The non-transitory, computer-readable storage medium of claim 15, wherein the discontiguous features of the asset comprise text that includes signature tokens, and wherein an individual relevancy model of the relevancy models determines a relevancy score for identifying related resources by:
calculating frequencies of the signature tokens among the multimodal resources;
ranking the multimodal resources according to the frequencies of the signature tokens, such that the multimodal resources with greater frequencies have higher ranks; and
identify related resources as the multimodal resources with ranks above a cut-off.

17. The non-transitory, computer-readable storage medium of claim 16, wherein the cut-off is determined by:
setting a test cut-off at a highest rank;
selecting a test group of related resources above the test cut-off and plotting them as points on a graph, such that the points form a cluster;
determining a center of the cluster;
determining distances between the points and the center of the cluster;
calculating a first measure of error based on the distances;
setting iteratively lower test cut-offs, selecting increasingly larger test groups of related resources, and calculating additional measures of error from the increasingly larger test groups based on measures of distance to centers of clusters;
comparing the additional measures of error with each other and with the first measure of error to determine a largest difference in error between test cut-offs; and
setting the cut-off at the test cut-off just before the largest difference in error.

18. The non-transitory, computer-readable storage medium of claim 15, wherein a correspondence of the logs comprises a common value that is shared between the logs, wherein the common value is associated with the asset, and wherein integrating the logs into a tracking history comprises:
joining the logs on the common value; and
combining redundant information from the logs.

19. The non-transitory, computer-readable storage medium of claim 15, wherein the logs are integrated into the tracking history using a correspondence model to determine a correspondence of the logs, wherein the correspondence includes a similarity, and wherein the correspondence model has been trained to output the similarity from logs provided as input.

20. The non-transitory, computer-readable storage medium of claim 15, wherein a threat level is estimated from the tracking history using a threat detection model, and wherein the threat detection model has been trained to output threat level estimates given tracking histories with known threat levels provided as inputs.
